(19) United States
(12) Patent Application Publication
(10) Pub. No.: US 2011/0011842 A1
(43) Pub. Date: Jan. 20, 2011

(54) Method and apparatus for receiving a universal 3 phase input voltage in a welding power source

(76) Inventor: Jose P. Thomas, Atwood, CA (US)

Correspondence Address: JOSE THOMAS, PO BOX 157, ATWOOD, CA, 92811, US

(21) Appl. No.: 12/505,505

(22) Filed: Jul. 19, 2009

(51) Int. Cl. B23K 9/10

(52) U.S. Cl. 219/130.21

(57) ABSTRACT

A method and apparatus for providing 3 phase input to a welding type power source is disclosed. The power source is capable of receiving wide range of 3 phase input voltage and rectifies the ac input into a dc power capable for welding application. The power source consist of two stages, the first stage is a phase shifted full bridge inverter running near to maximum duty cycle to minimize the losses in the converter which is followed by the second stage buck chopper. This buck chopper deals with wide voltage levels and incorporates a power factor correction circuit

### CROSS-REFERENCE TO RELATED APPLICATIONS

This application claims the benefit of provisional patent application EFS ID 5028814, application number 611630112 filed 2009 Mar. 24 by the present inventor.

### FEDERAL SPONSORED RESEARCH

Not Applicable

### SEQUENCE LISTING OR PROGRAM

Not Applicable.

### BACKGROUND

1. Field

This invention generally relates to 3 phase welding power source. Power sources typically convert a power input to a necessary or desirable power output tailored for a specific application. In welding applications, power sources typically receive a high voltage alternating current signal and provide a high current output welding signal. Around the world, utility power supplies are usually sine wave may be 200/208V, 230/240V, 380/415V, and 460/480V. The proposed power supply is capable of handling all the above voltage range.

2. Prior Art

There had been a lot of research done about welding power source. These power sources typically use a input boost stage which incorporates power factor correction stage followed by a inverter to carry the welding current.

Several different approaches were used to design welding power supplies, U.S. Pat. No. 5,601,741, U.S. Pat. No. 6,002,103, U.S. Pat. No. 6,849,827 B2, U.S. Pat. No. 7,049,546 B2 to James M Thommes and U.S. Pat. No. 6,329,636 B1, U.S. Pat. No. 6,815,639 B2, U.S. Pat. No. 6,987,242 B2 to Steven J Geissler are relatively in the same field. The invention discloses a 2 stage converter comprising of a input boost chopper and a inverter. The inverter topology is not very efficient particularly when the output voltage is around 10 Volts as compared to my proposed scheme. US patent US 2006/0213891 A1 to Elliott K Stava describes a novel approach to improve the quality of welding by using choppers does not aim to solve the problem of wide input voltage. Secondly, the output switches are been turned on/off through a logic controller. Using the same topology would need bulky output inductors. US patent US2006/0226130A1, publication US 2006/0175313 A1 to Todd E Kooken and U.S. Pat. No. 7,274,000 B2 to Robert L Dodge dated Sep. 25, 2007 deals with 3 stage converter having a boost for PFC correction, inverter with transformer for isolation and output chopper does not seem to be as efficient of using 2 stage converters as proposed.

### SUMMARY

A method and apparatus for providing 3 phase universal input to a welding type power source is disclosed. The power source is capable of receiving wide range of 3 phase input voltage and rectifies the ac input into a dc power capable for welding application. The power source consist of two stage the first stage is a phase shifted full bridge inverter running near to maximum duty cycle and aimed to minimize the effective losses in the power supply which is followed by the second stage buck chopper. This buck chopper deals with wide voltage levels and also incorporates a power factor correction circuit to achieve near to unity power factor

### DRAWINGS—FIGURES

FIG. 1 is the block diagram of a welding power supply constructed in accordance with the present invention.

FIG. 2 is the block diagram of one embodiment of a pre-regulator which consist of phase shift full bridge of FIG. 1.

FIG. 3 is the block diagram of one embodiment of the output controller (Buck chopper) and output portions of the controller in FIG. 1.

FIG. 4 is the block diagram for interconnection between stage 1 and stage 2

FIG. 5 is the circuit diagram of one embodiment of the first stage of FIG. 1

FIG. 6 is the circuit diagram of one embodiment of the controller of FIG. 1 i.e. second stage.

FIG. 7 is the circuit diagram of the alternative embodiment.

### DETAIL DESCRIPTION OF PREFERRED EMBODIMENT

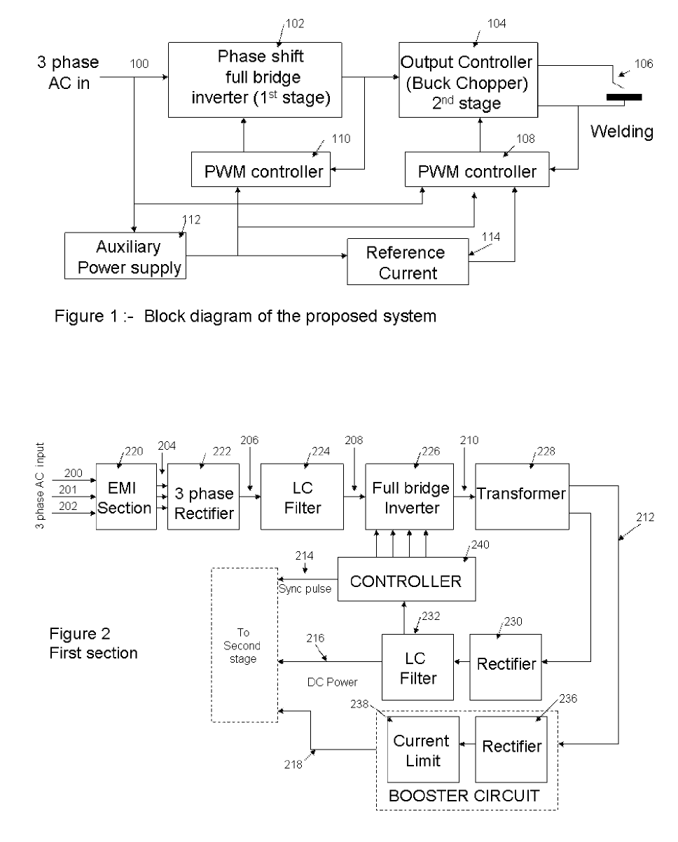

FIG. 1 shows the block diagram of the proposed system. The 3 phase input ac signal 100 is rectified by a 3 phase rectifier followed by a filter and connected to the first stage 102, which acts as a pre-regulator. The function of this block is to decrease the input voltage by a factor of 7 to 12 using a transformer on the secondary while the primary switches are running at almost full duty cycle. The duty cycle is varied, to account for the switching and the conduction losses on the switching device. The output of 102 is fed to synchronous buck chopper 104 which consist of forward and freewheeling MOSFETs. The duty cycle of switching depends on the output arc voltage and the input voltage. There can be N number of buck chopper synchronized with the 1^{st} t stage 102. The output of the converters 104 is connected to the welding electrodes by having a RF injection coil in series in case of non-contact start or directly connected to the welding electrodes in case of touch start. There are two methods of striking the arc. One of the easiest methods is by short circuiting the output terminals and then lifting the torch to provide a proper arc distance. The second method is a non-contact method where a high frequency pulse is fed between the welding electrode and work piece. This high voltage pulse ionizes the gas and facilitates the flow of welding current 106.

There are two PWM controllers in the proposed system. The first PWM controller 110 runs almost at maximum duty cycle to decrease the switching losses in the IGBT's. The control scheme may use UCC3895 phase shift modulator chip made by Texas Instruments. The second PWM controller 108 senses the output current and regulates the loop. The desired current setting comes from 114 which can be a potentiometer or a digital source or a computer interfaced source. The function of 114 is deliver a reference output signal corresponding to the output desired current in case of TIG and stick welding or to deliver a reference output signal corresponding to the output voltage in case of MIG welding. The reference source 114 may be programmed with parameters like background current, pulse current, background time, up-slope, down-slope etc . . . . An auxiliary power supply 112 is used to feed voltages to all the blocks as well as fans for the operation of this system.

FIG. 2 shows the enlarged block diagram of the first block 102 of FIG. 1. The 3 phase ac input is connected at lines 200, 201, 202. The three phase input is fed to 220 which has common mode chokes and differential mode chokes to avoid the switching noise in the system to escape to the mains. The output of 220 is fed to 222 which constitute a three phase rectifier. Standard three phase rectifier rated around 1200 Volts is used to rectify the input signal. The output of the rectifier in the form of DC voltage is fed to L and C circuit 224. The capacitor is designed to handle the ripple current in the full bridge inverter. The full bridge inverter 226 operates with phase shift modulation technology using UCC3895 chip made by Texas instruments. This scheme allows lowest switching losses on the full bridge when operating near to full load. The full bridge inverter is switched in the range of 25 KHz or at a higher frequency to avoid bulky transformer for the need of isolation. The output of the transformer is connected to rectifier 230 which rectifies at the switching frequency of the inverter. The rectifier diodes can be replaced by MOSFETs to decrease the losses. The output of the rectifier is fed to LC circuit 232 which is capable to handle the ripple current. There is an extra winding taken from the transformer 228 and fed 212 to booster circuit. The booster circuit consists of a rectifier 236 and a current limiting circuitry 238 which limits the current at 3 Amps. There are at least 3 signals connected to the second stage from the first stage. The first signal 214 is a sync pin which feeds the inverter switching signal to the second stage. By synchronizing the first and the second stage the output ripple current in the capacitor 232 gets significantly reduced. The dc power 216 is used to deliver welding power to the second stage. The booster supply 218 is used to initiate the arc as per the standard welding scheme.

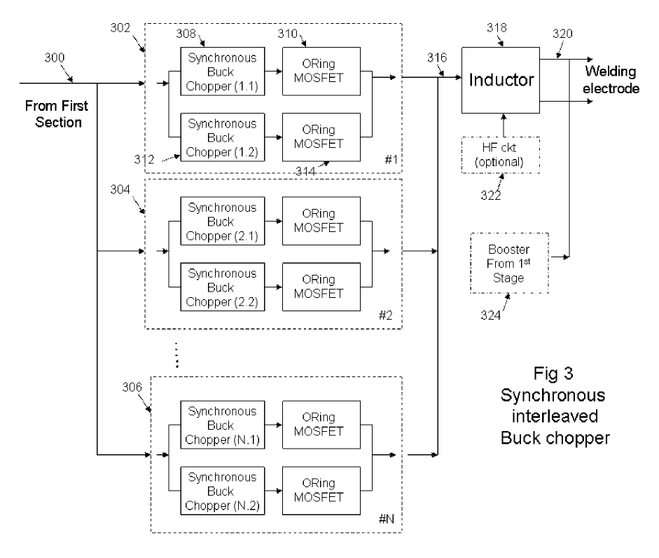

FIG. 3 shows the block diagram of synchronous interleaved buck chopper. The buck chopper consists of identical interleaved modules 302, 304, 306. Each block has two synchronous buck choppers running out of phase or in phase depending on the output current requirement of the module. Different techniques such as operating the output synchronous rectifier modules at a multiple frequency of the first stage would result in lower output ripple current. Each synchronous rectifier comprises of forward and freewheeling MOSFETs in order to minimize the conduction losses. For example, when the input voltage is in the order of 96 Volts and the desired output voltage is around 10 Volts the forward mosfet duty cycle results to 10% whereas the freewheeling mosfet is turned on for the remaining period of time till the current in the inductor goes to zero. This scheme provides higher efficiency, lower component cost and higher component density. Block 308 and 312 are running in sync with the first stage 102 switching inverter. When they are operated out of phase it helps in decreasing input and output ripple current and needs smaller inductor. When 308, 312 are used in phase it helps to reduce the peak current in the switches. The output is connected together through an ORing MOSFET. The ORing MOSFET 310, 314 has an internal diode which is used at lower current till the rated ripple current and when the output current exceeds the ripple current value the MOSFET is turned on. Using an ORing MOSFET decreases the conduction losses in the diode. The output is fed through 316 to a output inductor which is magnetically coupled to a RF injection coil. RF circuit 332 is used to initiate the weld. The booster circuit 324 is derived from the first stage and is connected across the welding electrodes to maintain a higher open circuit voltage OCV during arc striking.

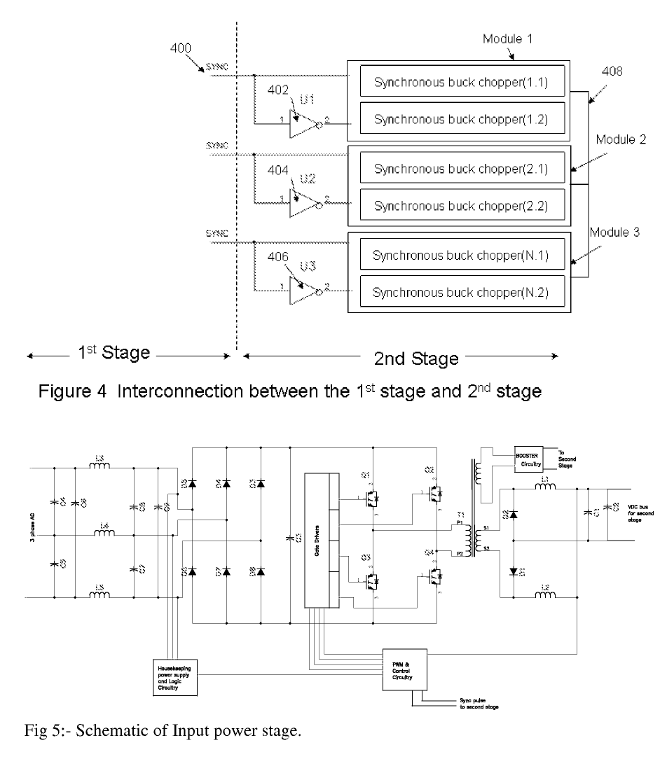

FIG. 4 shows the interconnection between the first stage and the second stage. The sync 400 signal derived from the first stage is used in the second stage. The output of both the synchronous buck chopper 1.1 and 1.2 are made out of phase through an inverter 402. This is similarly done by 404, 406. Module 1, 2 and 3 are identical and is connected with each other though current share signal 408.

FIG. 5 shows the schematic of input power stage. EMI section consist of common mode inductor L3, L4, L5, with X capacitors C4, C5, C6, C7, C8, C9 and few Y capacitors. The output of the EMI filter is fed to diode rectifier D3-D8 which rectifies the input 3 phase AC into a DC power. The output is filtered through a LC circuit C3 or just a capacitor to eliminate voltage switching spikes and carry the input ripple current. Q1, Q2, Q3, Q4 are IGBTs rated around 1200 Volts and capable to switching input current as required by the load 106. The switching frequency signal is fed to a ferrite core transformer T1 which has two secondary windings. One for booster voltage and other for delivering the output power for the load. The booster circuit exhibits current limit around 3 Amps to 5 Amps and is capable of providing the open circuit voltage. Housekeeping circuitry provides voltages for all other sections to turn on. The PWM control circuitry runs at near to full duty cycle and senses the input and output voltage for the same. The inverter switching pulse is given to the second stage.

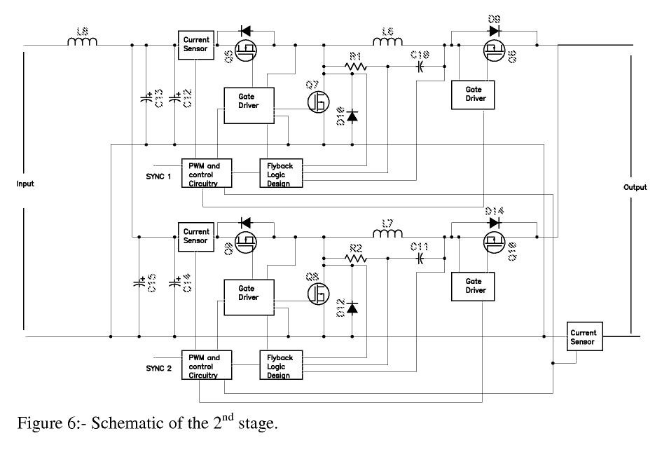

FIG. 6 is a schematic for the output buck chopper. The buck chopper input waveform is in phase with the rectified input of the 1^{st} stage with little filtering. Inductor L8 and C13, C12, C15, C12 helps to eliminate noise to enter the first stage. The PWM controller works out of phase with each other. Current is shared between each stage by means of feeding the current information to both sides. This topology may use a master-slave configuration or would be a democratic load share. Q5, Q9 are the forward MOSFET which runs at a duty cycle to maintain the output voltage. Q7, Q8 are freewheeling MOSFETs used to freewheel the inductor current. Special circuit is used for flyback gate drive to facilitate the turn off at the time of turn on, turn off and lighter loads. The current sensor at the input towards Q5, Q9 is used for pulse by pulse current limit. The output current is sensed by a different current sensor.

### Alternative Embodiment

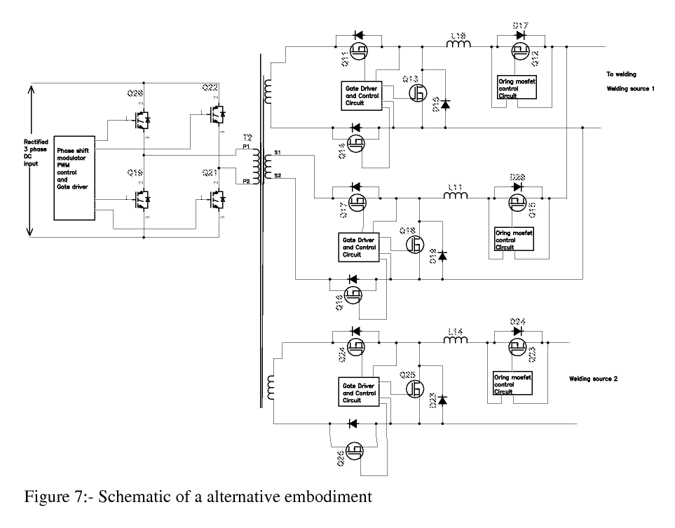

There are various other schemes which can be used to achieve the same results. FIG. 7 shows a schematic of a power stage. The rectified 3 phase ac input is applied to the full bridge inverter stage. The full bridge inverter runs opens loop at a maximum duty cycle and the transformer steps down the input voltage by a factor of 8.5. The Secondary circuit consists of MOSFET switches synchronized with the primary switching waveform. MOSFETs Q11, Q17, and Q24 acts as a buck chopper and Q13, Q18 and Q25 are used to freewheel the inductor energy. MOSFET Q14, Q16 and Q26 turn on in the same phase with Q11, Q17 and Q24 respectively. This alternative eliminates using secondary rectification using diodes, is very efficient but needs to be synchronized by the leading edge of the primary switching waveform.

Other control circuitry and consideration in both the above design:

The buck chopper stage has 3 control loops. The first is a pulse by pulse current control, second is output current regulation and the third control loop is current share circuitry.
Pulse by pulse current limit:—It is been sensed by the current transformer and the PWM converter offers peak current limit during the switching cycle.
Output current regulation:—The output current is regulated by sensing the output current through a Hall Effect sensor and the error amplifier does the corrective action.
Current Share Circuitry—Each power supply feeds an analog voltage to the current share line corresponding to the current flowing through that stage. Democratic current share circuitry is used to check the current flowing through the module and adjust their independent current. The other option is to use master-slave current share mode.

ORing MOSFETs:—ORing MOSFET is controlled by their individual power supply. Initially, when the ORing MOSFET is off, the output welding current flows through its internal diode. Whenever the output current is greater than the ripple current exhibited by the load, ORing MOSFETs are turned on. Current is sensed in each individual module and also fed to regulate the buck chopper control loop. Prior Art uses a common signal to turn on the ORing switch which is programmed by a external controller.

Slope compensation:—Slope compensation is incorporated in individual units. Slope compensation is one of the important aspects of this design. The control circuit in the present design is a peak current mode controller. It senses the peak of the output current to provide pulse by pulse current limit. At lower input voltages the pulse width is maximum as well as the RMS current level but at a higher input voltage, the pulse width goes narrower and the RMS current lowers. Slope compensation is used to circumvent this issue and is done by sensing the input voltage.

Advantage of using out of phase interleaved synchronous buck chopper is the input and the output ripple is cancelled. Secondly each section carries half the RMS current. The output inductor value can be reduced for the same ripple current. Running the buck choppers in phase decreases the peak current through the MOSFETs, thus resulting in a lower switching loss and a higher packing density.

Synchronous buck chopper:—The output of the buck chopper has forward and flyback MOSFET. When the output current exceeds the ripple current the flyback MOSFET is turned on thus avoiding the sinking of current from the other paralleled buck chopper. The flyback MOSFET is also turned off during the turn on of the power supply thus allowing soft start.

Power factor correction (PFC):—Power factor is relative easy to implement when the input is from a 3 phase ac source. The rectified signal has a valley voltage of 1.5 times its RMS value and the peak voltage of 1.75 its RMS value. The output of the buck chopper is less than the valley voltage thus enabling the circuit to always work in a buck mode.

The control circuit incorporates a error amplifier which senses the desired welding current and the actual current. The output of the error amplifier is given to a transconductance amplifier with one input as the rectified sine wave. The output of the transconductance amplifier is given to a PWM generator which compares with the ramp voltage and delivers a pulse width modulated signal to turn on and off the forward and flyback MOSFETs.

Advantages:—From the description above, a number of advantages of some embodiments of my proposed welding power source become evident
(a) When the desired output voltage for welding is around 10 Volts, while the input is operated from a higher 3 phase input, the corresponding duty cycle results to less than 10%. The switching loss in the buck chopper seems to be a serious consideration. To solve this issue the front end full bridge inverter reduces its own duty cycle and lowers the average voltage fed to the buck chopper.
(b) When two phase interleaved buck choppers are operated in synchronization to the primary switching, it reduces the LC filter as well as, ripple current is cancelled and hence EMI is reduced.
(c) Smaller value of output inductors and it runs thermally cooler than using one inductor due to lower peak current.
(d) Since the primary full bridge primary input section incorporates pulse by pulse current limit feature, the overall power source seems to be more reliable.
(e) The secondary buck chopper has a lower bandwidth typically less than half of the input ac frequency due to power factor correction circuitry. This power source is quite adequate for traditional welding application. On the other side it is very compact.
(f) This power source is compact, since the primary isolation is done at a higher switching frequency 25 KHz and above, at max duty cycle, while the output is switched with a lower bandwidth, which shares the advantage of compact size and nominal welding feature at a lower cost.
(g) Output switching MOSFETs used for the buck choppers are relatively easy to find because of their lower voltage rating. With the modern technology, low voltage MOSFETs are available with very low drain to source resistance, thus
(h) increases efficiency and needs less space. Power MOSFETs of similar voltage rating are also available as surface mount components.
(i) The phase shift PWM controller used in the front end converter implements control of a full bridge power stage by phase shifting the switching of one half bridge with respect to the other. It allows constant frequency pulse width modulation in conjunction with resonant zero voltage switching to provide high efficiency at high frequencies. Typical control circuitry may involve Texas instrument chip UCC3895.

### CONCLUSION, RAMIFICATION AND SCOPE

The power source would see a improved power factor, increased efficiency, smaller size, lighter weight, and cheaper solution to the existing welding machines on the other side it will have smaller system bandwidth which will be similar to the traditional welding machines.

### SPECIFICATION

The enclosed application discusses about a universal 3 phase input welding power source with the front end inverter operating in open loop or semi-regulated. The output of the inverter is step down using a transformer and rectified and fed to buck chopper. The buck chopper consist of one or more converter operating in parallel and designed to deliver the welding load requirement. The buck chopper incorporates a power factor correction circuitry

Under the described invention the following is claimed:

1. A welding system capable of receiving a range of 3 phase input voltages and spanning at least two input utility voltages comprising:
an input circuit configured to receive any 3 phase input voltage within the range of input voltages and configured to provide a first dc signal;
a converter configured to receive first dc signal and provide a ac signal to a step down transformer operating near maximum duty cycle;
a rectifier and filter circuit to convert the ac signal from the transformer to dc;
a output circuit utilizing at least one buck chopper configured to receive the converter output and to provide a welding signal;
a controller including a power factor correction circuit, configured to provide at least one control signal to the output converter; and
an auxiliary power source configured to receive the any input voltage within the range of input voltage within the range of input voltages and configured to provide a control power signal to the controller.

2. An welding system as defined in claim no 1, using a intelligent program or hardware to minimize the losses in the second stage by sensing the output welding voltage and first stage input dc voltage to adjust the pulse width of the second stage.

3. The system of claim 1, wherein the output buck chopper includes a power factor correction circuitry.

4. The system in claim 3, where the converter includes buck chopper circuit.

5. The system of claim 1, wherein the output converter consist interleaved two or more buck choppers sharing the output current through current share signal connected to all the modules

6. The system of claim 1, wherein the output buck chopper uses MOSFETs.

7. The system of claim 1, wherein the first inverter stage, steps down the input voltage by a factor of 7 to 12 and is semi-regulated.

8. An electric arc welding as defined in claim no 1, capable of handling 200 Amps to 1000 Amps of current.

9. The system of claim 1, where the switching of the buck choppers are synchronized with the second stage.

10. The system of claim 1, where the primary switching is done by one or more full bridge inverter feeding multiple primary windings of the same transformer.

11. A welding type power source capable of receiving a range of 3 phase input voltages and spanning at least two input utility voltages comprising:
an input circuit configured to receive any 3 phase input voltage within the range of input voltages and configured to provide a first dc signal;
a converter configured to receive dc signal and provide a ac signal to a step down transformer operating at maximum duty cycle and in open loop mode;
a output synchronous rectifier circuitry which consist of a buck chopper circuitry configured to provide a welding signal;
a controller including a power factor correction circuit, configured to provide at least one control signal to the output converter;
an auxiliary power source configured to receive the any 3 phase input voltage within the range of input voltages and configured to provide a control power signal to the controller.

12. The system in claim 10, wherein the output buck chopper uses MOSFETs.

13. The system in claim 10, wherein the output buck chopper includes a power factor correction circuitry.

14. The system in claim 10, wherein the output buck chopper MOSFETs are switched with respect to the primary switching waveform

15. The system in claim 10, wherein additional buck choppers from the second stage can be independently regulated and be used for welding

16. An electric arc welding as defined in claim 10, capable of handling 200 amps to 1000 amps of current.

17. a system of claim 10, wherein the first inverter stage operates at maximum duty cycle.

18. a system of claim 10, wherein multiple outputs are taken from the transformer with independent buck choppers used for multiple welding outputs.

19. a apparatus of claim 10, wherein a buck chopper is directly connected to the transformer without diode rectifier.

20. The system of claim 10, wherein the output buck chopper uses MOSFETs and is synchronized with the second stage primary switching waveform.
